(19) United States
(12) Patent Application Publication
(10) Pub. No.: US 2019/0312534 A1
(43) Pub. Date: Oct. 10, 2019

(54) MOTOR DRIVE DEVICE

(71) Applicant: Toshiba Lifestyle Products & Services Corporation, Kawasaki-shi (JP)

(72) Inventor: Toshimitsu AIZAWA, Minato-ku (JP)

(73) Assignee: Toshiba Lifestyle Products & Services Corporation, Kawasaki-shi (JP)

(21) Appl. No.: 16/449,650

(22) Filed: Jun. 24, 2019

Related U.S. Application Data
(63) Continuation of application No. PCT/JP2018/001599, filed on Jan. 19, 2018.

(30) Foreign Application Priority Data
Jan. 20, 2017 (JP) 2017-008482

(51) Int. Cl. H02P 6/15; H02P 6/28; H02P 6/30; H02M 7/5387; H02M 1/08

(52) U.S. Cl. CPC H02P 6/15; H02P 6/28; H02M 2001/0009; H02M 7/53871; H02M 1/08; H02P 6/30

(57) ABSTRACT

According to an embodiment of the present invention, a control circuit of a motor drive device activates a first timer according to the rotational position of a motor, controls, on the basis of the time counted by the first timer, the on-timing of positive-side switching elements that constitute an inverter circuit, and energizes the motor. The control circuit also activates a second timer according to the on-timing, controls the off-timing of the positive-side switching elements, on the basis of the time counted by the second timer, sets negative-side switching elements of two opposing arms to be in an on-state to cause a reflux current to flow, and then changes an energization direction to the motor. When the rotational position is set to a position for activating the first timer before the on-timing, turning on of the positive-side switching elements and activation of the second timer, which are scheduled to be performed at the on-timing, are carried out.

### TECHNICAL FIELD

Embodiments of the present invention relate to a motor drive device.

### BACKGROUND ART

A brushless DC motor has been often used in recent years from viewpoints of energy saving and noise reduction. In the brushless DC motor, it is required to switch energization timing according to a position of its rotator. Therefore, a position of the rotator is detected by a magnetic position sensor such as a Hall effect sensor, and timing at which the motor is energized is switched corresponding to edges of a sensor signal to drive the motor.

In this case, by switching the energization timing before an edge of the sensor signal arrives to perform lead angle control, or to change energization time, a motor current can be adjusted. Such control can be achieved using timers, for example. For example, it can be considered to cause a timer 1 to start counting at the timing of an edge of the sensor signal, thereby starting energization by an interrupt of the timer or the like, and to cause a timer 2 to start counting, thereby ending the energization by an interrupt of the timer. Note that, Patent Literature 1 is presented as an example of energization control for a brushless DC motor using timers.

### CITATION LIST

### Patent Literature

Patent Literature 1: Japanese Patent Lain-Open No. 2005-117895

### DISCLOSURE OF THE INVENTION

### Technical Problem

However, with the above-mentioned configuration, when an edge interval of the sensor signal is shortened due to an abrupt acceleration of the motor or the like, it is conceivable that a subsequent edge or a subsequent energization timing occurs before the energization time is completed, which results in anomalous energization state to cause a large current to flow.

Therefore, a motor drive device capable of preventing breakdown of control and of controlling at a lower lead angle when two timers are used for the control is provided.

### Solution to Problem

A motor drive device of an embodiment includes:

a power conversion circuit that is configured by connecting, in parallel, a plurality of arms respectively including series circuits of respective positive-side and negative-side switching elements, and that drives a motor,

a control circuit generating and outputting an on/off signal to each of the switching elements constituting the power conversion circuit to control the motor, and

a rotational position detector detecting a rotational position of the motor;

wherein the control circuit includes a first timer and a second timer,

activates the first timer according to the rotational position, controls on-timing of the positive-side switching elements on the basis of the time counted by the first timer, and thereby energizes the motor,

activates the second timer according to the on-timing, controls off-timing of the positive-side switching elements on the basis of the time counted by the second timer, sets negative-side switching elements of two opposing arms to be in an on-state to cause a reflux current to flow, and then changes the energization direction to the motor, and

when the rotational position is set to a position for activating the first timer before the on-timing, turning on of the positive-side switching elements and activation of the second timer, which are scheduled to be performed at the on-timing, are carried out.

### BRIEF DESCRIPTION OF DRAWINGS

FIG. 1 is a first embodiment and is a block diagram showing a configuration of a motor drive device.

FIG. 2 is a timing diagram showing normal operation of an envisaged conventional technology.

FIG. 3 is a flowchart illustrating interrupt processing in association with occurrence of an edge of a rotational position signal.

FIG. 4 is a flowchart illustrating timer 1 interrupt processing.

FIG. 5 is a flowchart illustrating timer 2 interrupt processing.

FIG. 6 is a timing diagram (Part 1) showing operation when an anomaly occurs.

FIG. 7 is a timing diagram (Part 2) showing operation when an anomaly occurs.

FIG. 8 is a flowchart illustrating interrupt processing in association with occurrence of an edge of a rotational position signal in the present embodiment.

FIG. 9 is a flowchart illustrating timer 1 interrupt processing.

FIG. 10 is a timing diagram (Part 1) showing operation when an anomaly occurs.

FIG. 11 is a timing diagram (Part 2) showing operation when an anomaly occurs.

FIG. 12 is a diagram showing each actual signal waveform corresponding to when the anomaly occurs in FIG. 6.

FIG. 13 is a diagram showing each actual signal waveform corresponding to when the anomaly occurs in FIG. 10.

FIG. 14 is a diagram showing each actual signal waveform corresponding to when the anomaly occurs in FIG. 7.

FIG. 15 is a diagram showing each actual signal waveform corresponding to when the anomaly occurs in FIG. 11.

### BEST MODE FOR CARRYING OUT THE INVENTION

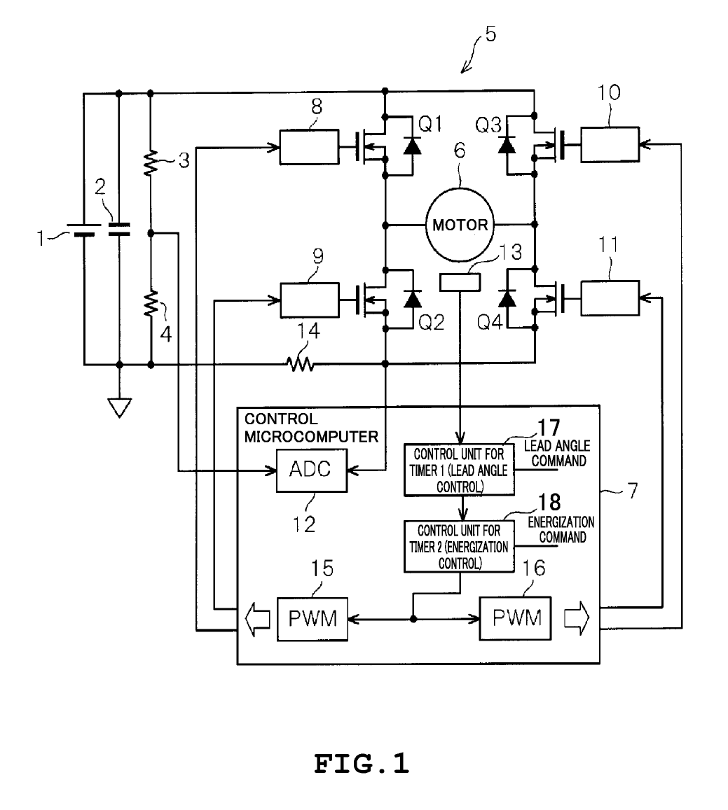

Hereinafter, an embodiment will be described with reference to the drawings. In FIG. 1 showing a configuration of a motor drive device, a smoothing capacitor 2, a series circuit of resistive elements 3, 4 and an inverter circuit 5 are connected in parallel to an DC power supply 1. The inverter circuit 5 corresponding to a power conversion circuit includes four N-channel MOSFETs Q1 to Q4 connected in an H-bridge configuration. In addition, stator winding (not shown) of a single-phase brushless DC motor 6 is connected between a common connection point of an arm being a series circuit of the FET_Q1 and FET_Q2 and a common connection point of an arm being a series circuit of the FET_Q3 and FET_Q4. Note that, the FET_Q1 and FET_Q3 correspond to positive-side semiconductor switching elements and the FET_Q2 and FET_Q4 correspond to negative-side semiconductor switching elements.

Switching of the FET_Q1 to FET_Q4 is controlled by a control microcomputer 7. The control microcomputer 7 corresponding to a control circuit outputs a gate drive signal to a gate of each of the FET_Q1 to FET_Q4 via respective gate drive circuits 8 to 11. A common connection point of the resistive elements 3, 4 is connected to an input terminal of the control microcomputer 7. The control microcomputer 7 performs A/D conversion to divided voltage of the DC power supply 1 using an A/D converter 12 and reads the result.

Further, a Hall effect sensor 13 is disposed in the motor 6 and an output terminal of the Hall effect sensor 13 is connected to the input terminal of the control microcomputer 7. The Hall effect sensor 13 detects a magnetic field of a permanent magnet disposed on a rotator of the motor 6 and outputs a rotational position signal to the control microcomputer 7. The control microcomputer 7 switches an energization direction with respect to the stator winding of the motor 6, that is, an rotational direction of the motor 6, in accordance with the rotational position signal. The Hall effect sensor 13 corresponds to a rotational position detector.

In a power supply line connecting between the inverter circuit 5 and a ground being a negative-side terminal of the DC power supply 1, a resistive element 14 being a current detector is inserted. A terminal on the side of the inverter circuit 5 of the resistive element 14 is connected to the input terminal of the control microcomputer 7 and the control microcomputer 7 performs A/D conversion to terminal voltage of the resistive element 14 using the A/D converter 12 and reads the result.

The control microcomputer 7 includes a first PWM circuit 15 and a second PWM circuit 16, and the first PWM circuit 15 outputs a gate signal to FET_Q1 and FET_Q2 side, whereas the second PWM circuit 16 outputs a gate signal to FET_Q3 and FET_Q4 side. The control microcomputer 7 includes a control unit 17 for timer 1 and a control unit 18 for timer 2 that incorporate the timer 1 and the timer 2, respectively. The timers 1, 2 are programmable and correspond to first and second timers, respectively. The timer 1 is activated by an edge of the rotational position signal output by the Hall effect sensor 13 and is used for lead angle control in the motor 6. The timer 2 is activated when the counting of the timer 1 is completed and is used for energization time control in the FET_Q1 and FET_Q3.

As is well known, in the H-bridge inverter circuit 5, the stator winding of the motor 6 is energized, for example, in a positive direction by simultaneously turning on the FET_Q1 and FET_Q4, and is energized in an opposite direction by simultaneously turning on the FET_Q2 and FET_Q3.

<Description of Envisaged Conventional Technology>

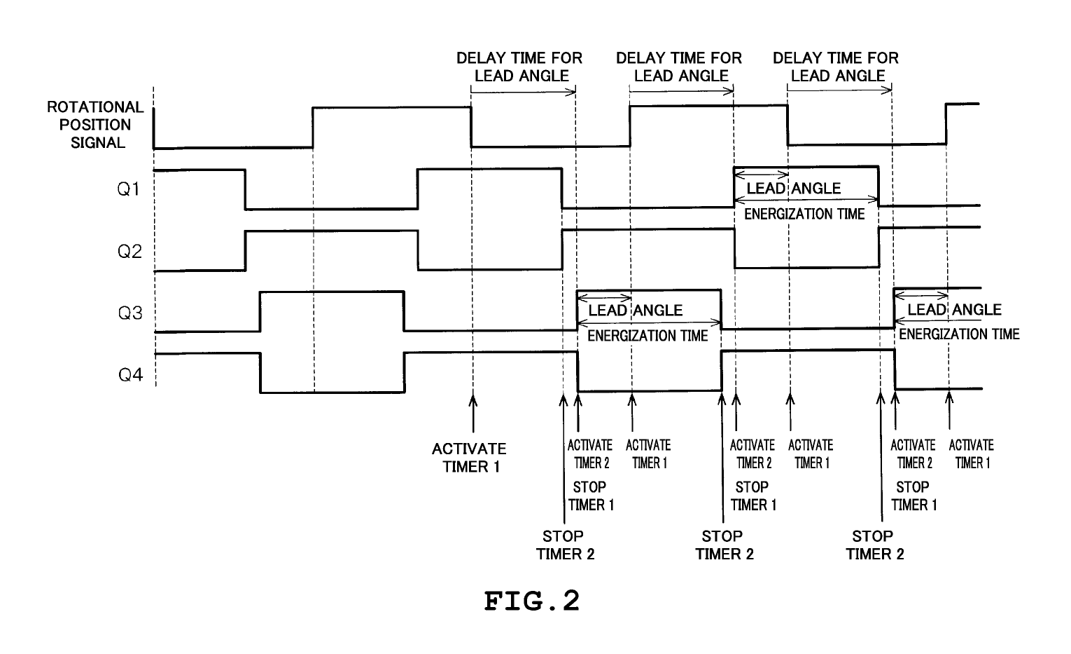

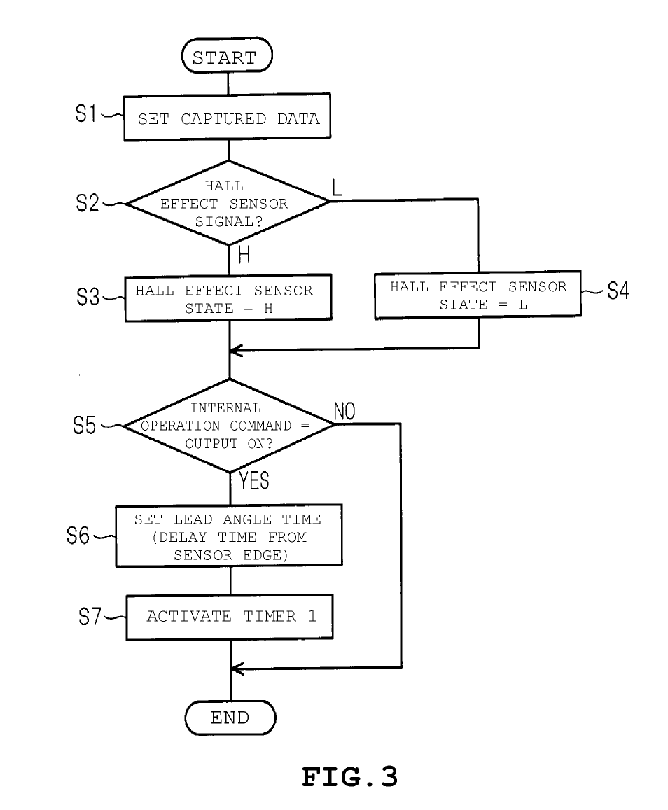

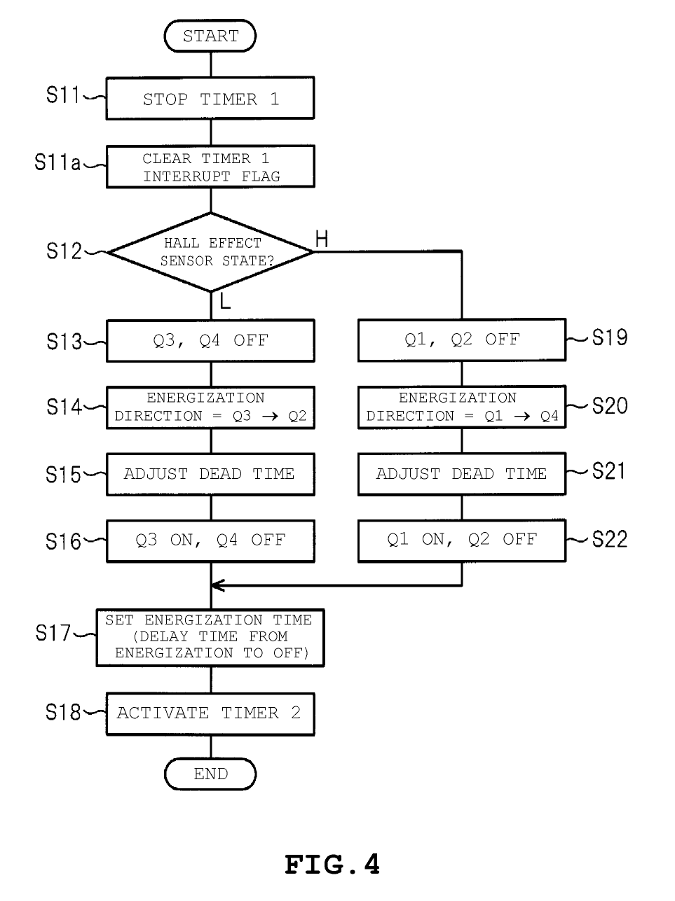

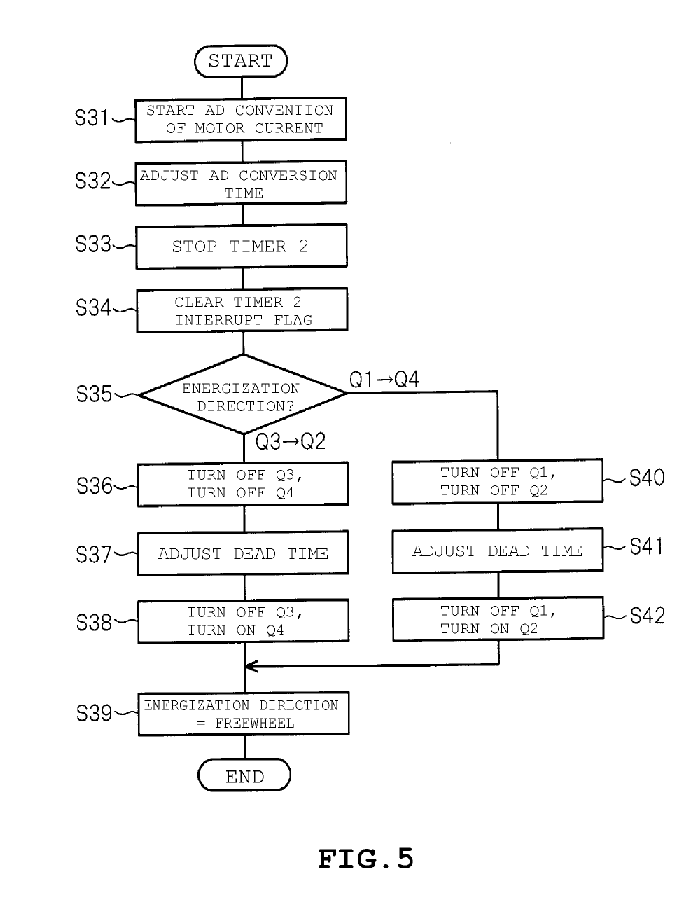

Here, for the convenience of description, a conventional technology envisaged below will be described with reference to FIG. 2 to FIG. 7. The conventional technology can be achieved by the above-mentioned configuration of the control microcomputer 7, and as shown in FIG. 2, provides such a control sequence as processing (1) to (3) below. FIG. 3 is a flowchart illustrating interrupt processing in association with occurrence of the edge of the rotational position signal, FIG. 4 is a flowchart illustrating timer 1 interrupt processing, and FIG. 5 is a flowchart illustrating timer 2 interrupt processing.

(1) The timer 1 is activated by the edge (START in FIG. 3) of the rotational position signal output by the Hall effect sensor 13 (S7). At this time, a delay time from the signal edge is set (S6) to the timer 1 to perform the lead angle according to the input lead angle command of the motor 6 using the previous edge interval time of the rotational position signal (S1). Note that, “INTERNAL OPERATION COMMAND=OUTPUT ON” in step S5 shown in FIG. 3 is a situation in which the inverter circuit 5 provides a command to drive the motor 6.

(2) When set time is counted by the timer 1, a timer 1 interrupt occurs (START in FIG. 4). In processing in association with this interrupt, when the signal edge is “rising” (H in S12), the FET_Q1 is turned on (S22), whereas when the signal edge is “falling” (L in S12), the FET_Q3 is turned on (S16) to start energization of the motor 6. Thereafter, the timer 2 is activated (S18). At this time, the energization time according to the energization command is set to the timer 2 (S17). In addition, the timer 1 is stopped to prevent malfunctioning (S11), and a timer 1 interrupt flag is cleared (S11a).

Note that, at the time when the FET_Q1 is turned on, counting by the timer 2 in a control in processing (3) described below has been already completed, and in accordance with that, the FET_Q4 has been turned on; therefore, the energization is performed in a direction from the FET_Q1 to the FET_Q4. As in the same way, at the time when the FET_Q3 is turned on, the FET_Q2 has been already turned on; therefore, the energization is performed in a direction from the FET_Q3 to the FET_Q2.

(3) When set time is counted by the timer 2, a timer 2 interrupt occurs (START in FIG. 5). In processing in association with this interrupt, the positive-side FET_Q1 or FET_Q3 being turned on depending on the energization direction at present is turned off (S40, S36). Note that, A/D conversion of current detected by the resistive element 14 is started before the FET is turned off (S31). Thereafter, the timer 2 is stopped so as to prevent malfunction (S33) as with the timer 1.

In addition, when the FET_Q3 and FET_Q4 are turned off in step S36 and the FET_Q1 and FET_Q2 are turned off in step S40, the FET_Q4, FET_Q2 are respectively turned on in steps S38, S42 after dead-time waiting is performed in steps S37, S41. This makes reflux current flow through the inverter circuit 5, whereby to bring flowing current to the motor 6 into a “freewheeling” state (S39). Thereafter, when an edge of the rotational position signal in an opposite direction occurs, the processing is transitioned to the processing (1).

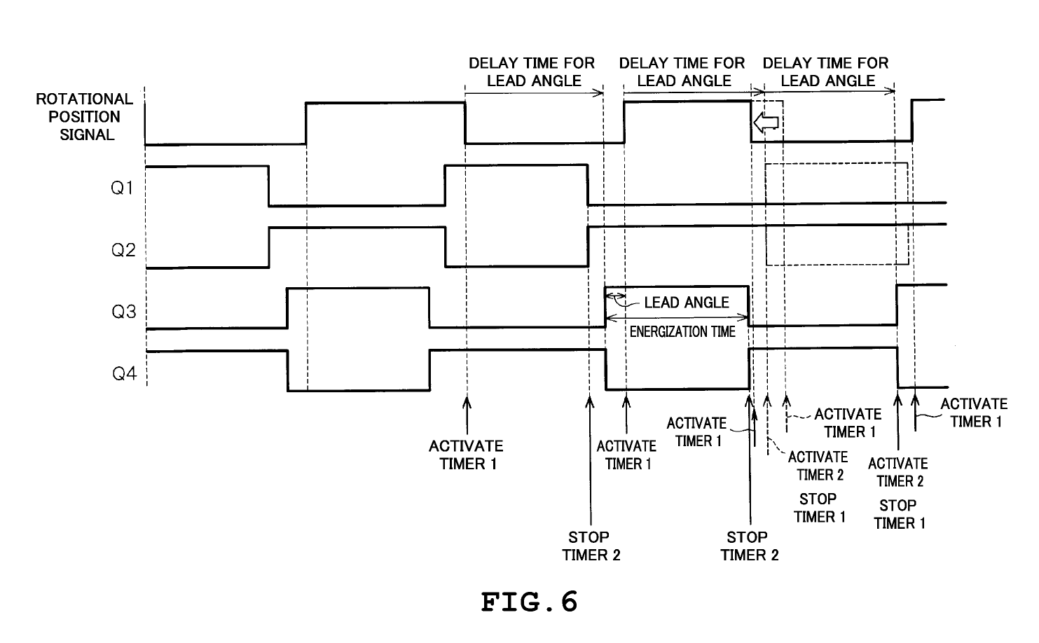

It is assumed that the following anomaly occurs for this conventional technology. The conventional technology is not configured to handle the occurrence of anomaly. In the case shown in FIG. 6, since an edge of the rotational position signal arrives earlier due to abrupt acceleration of the motor 6 or the like, before counting operation of the timer 1 is completed, i.e., before a delay time for lead angle elapses, an activation condition of the subsequent timer 1 occurs. This prevents desirable control.

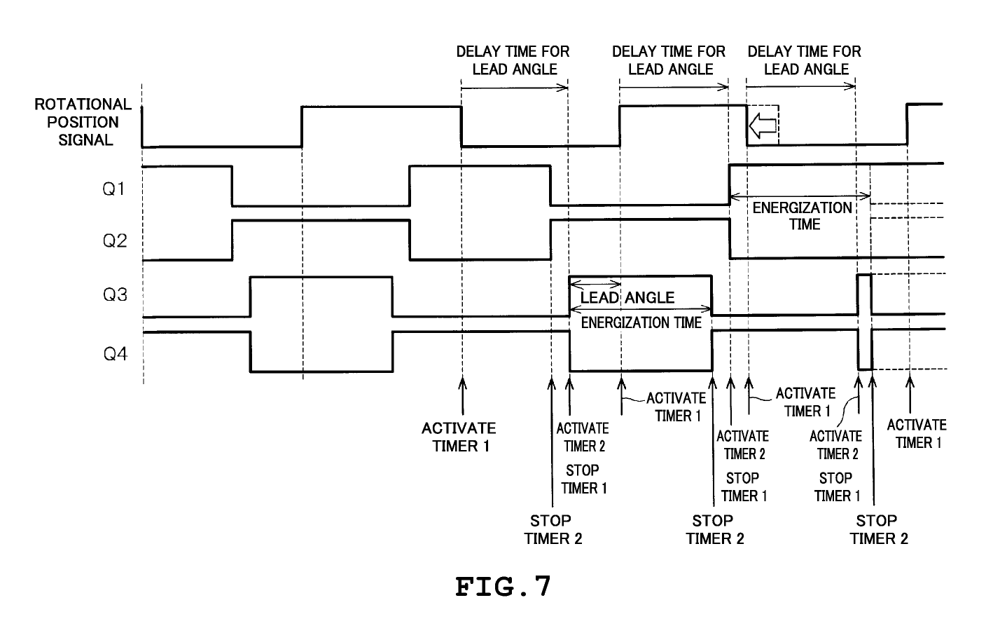

Furthermore, in the case shown in FIG. 7, since an edge of the rotational position signal arrives earlier as well, before counting operation of the timer 2 is completed, i.e., before the energization time elapses, a stop condition of the subsequent timer 1 occurs. This also prevents desirable control.

<Anomaly Handling According to Present Embodiment>

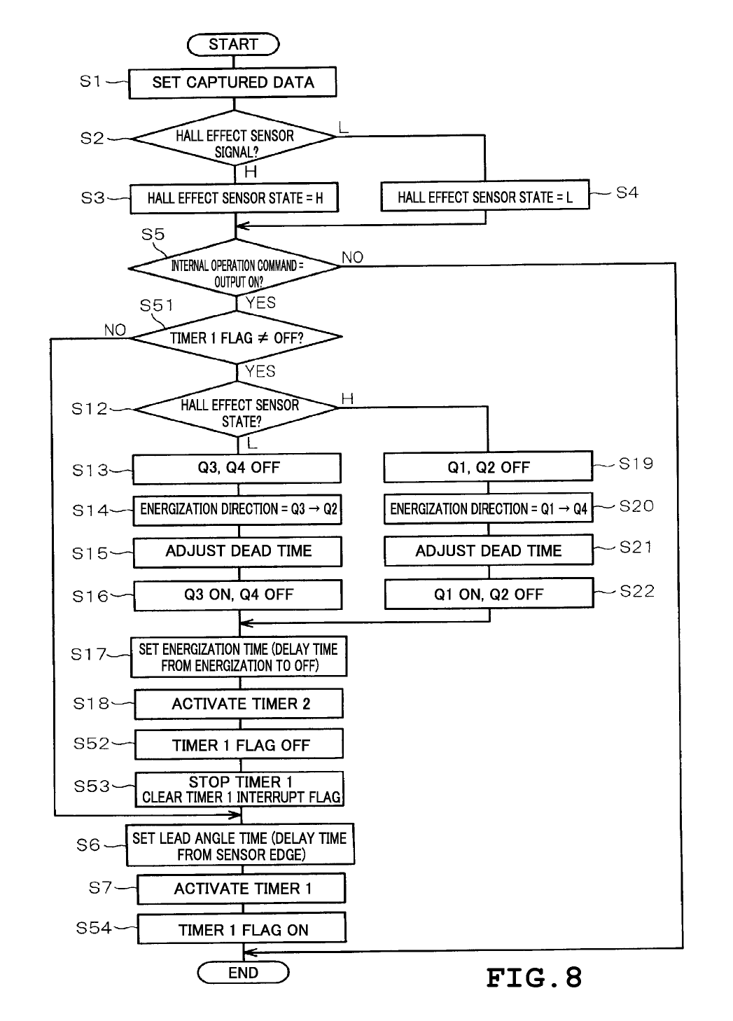

Therefore, in the present embodiment, to handle the aforementioned anomaly occurrence, in the interrupt processing in association with occurrence of an edge shown in FIG. 8, new steps S51 to S54 are added, and steps S12 to S22 in the timer 1 interrupt processing are also executed. After execution of step S7, a “timer 1 flag” is turned on (S54) before ending processing. In addition, when it is determined to be “YES” in step S5, it is determined whether the “timer 1 flag” is not turned off (S51), and then steps S12 to S22 are executed when it is not turned off (YES).

After execution of step S18, the “timer 1 flag” is turned off (S52) to stop the counting operation of the timer 1 and clear a “timer 1 interrupt flag” (S53). Thereafter, steps S6 and S7 are executed. On the other hand, when it is determined to be “NO” in step S51, the processing is transitioned to step S6.

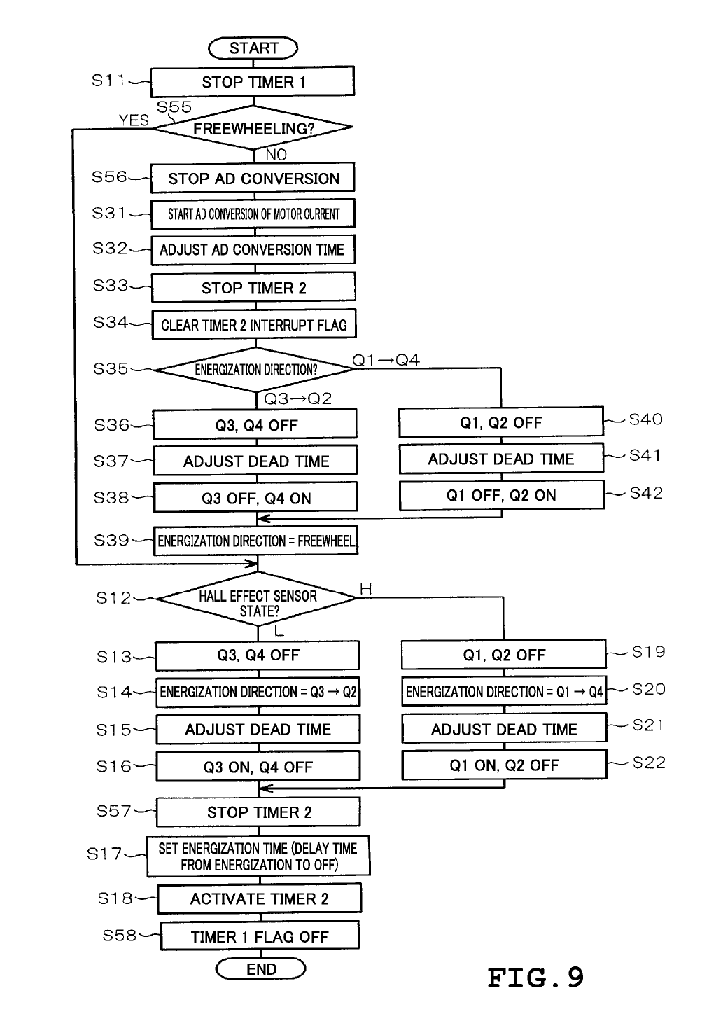

Furthermore, in the timer 1 interrupt processing shown in FIG. 9, new steps S55 to S58 are added, and steps S31 to S42 in the timer 2 interrupt processing are also executed. After execution of step S11, it is determined whether the current energization state is “freewheeling” or not (S55), and when it is not “freewheeling” (NO), A/D conversion processing is once stopped (S56) before steps S31 to S42 are executed. Thereafter the processing is transitioned to step S12. When it is determined to be “YES” in step S55, the processing is also transitioned to step S12. After execution of steps S16 and S22, the timer 2 is stopped (S57), and steps S17 and S18 are executed before “the timer 1 flag” is turned off (S58). Note that, the timer 2 interrupt processing is the same as the one shown in FIG. 5.

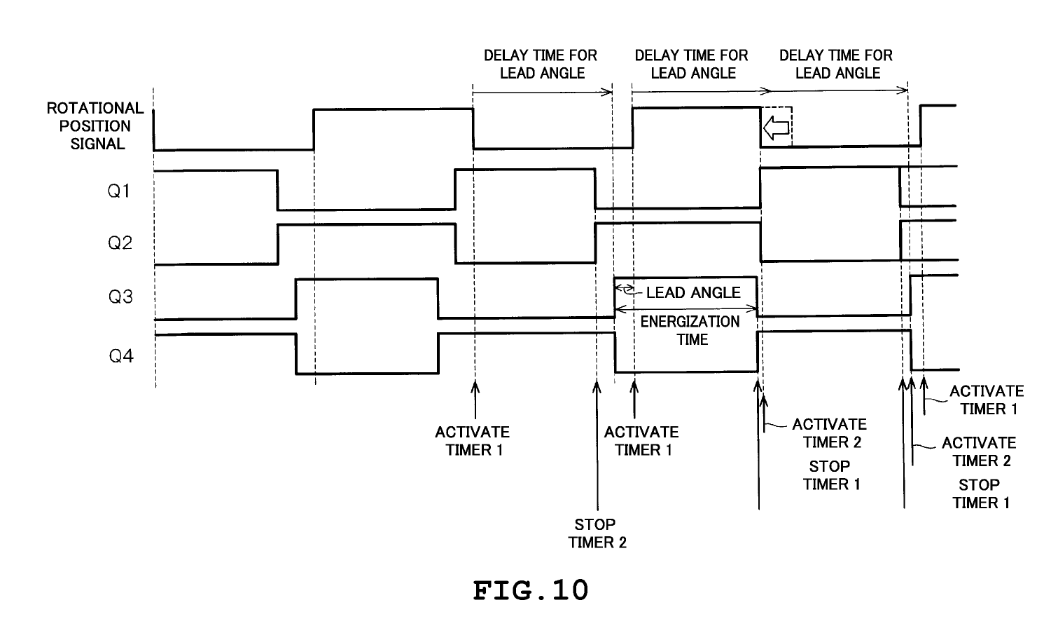

Consequently, anomaly handle processing is performed as follows: In FIG. 10 that corresponds to the case shown in FIG. 6, in the edge interrupt processing, unless the “time 1 flag” is turned off (S51; YES), the edge interrupt has occurred during counting operation by the timer 1. Therefore, steps S12 to S22 in the timer 1 interrupt processing are executed within the edge interrupt processing. Therefore, the processing is once reset at this point to activate the timer 2 (S18 in FIG. 8), and the timer 1 is stopped (S53) and re-activated (S7).

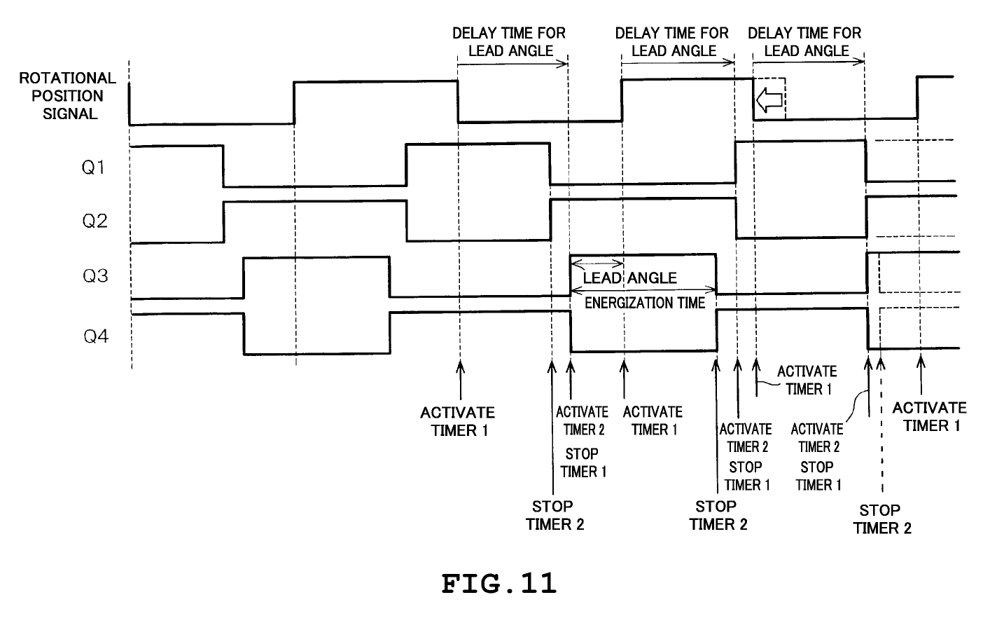

In FIG. 11 that corresponds to the case shown in FIG. 7, unless the current energization state is “freewheeling” when the timer 1 interrupt occurs (S55; NO), it is indicated that step S39 in the timer 2 interrupt processing has not been executed. Therefore, steps S31 to S42 in the timer 2 interrupt processing are executed in advance within the timer 1 interrupt processing. Consequently, the processing is once rest at this point to stop the timer 2 (S33 and S57 in FIG. 9). Thereafter, the timer 2 is re-activated (S18).

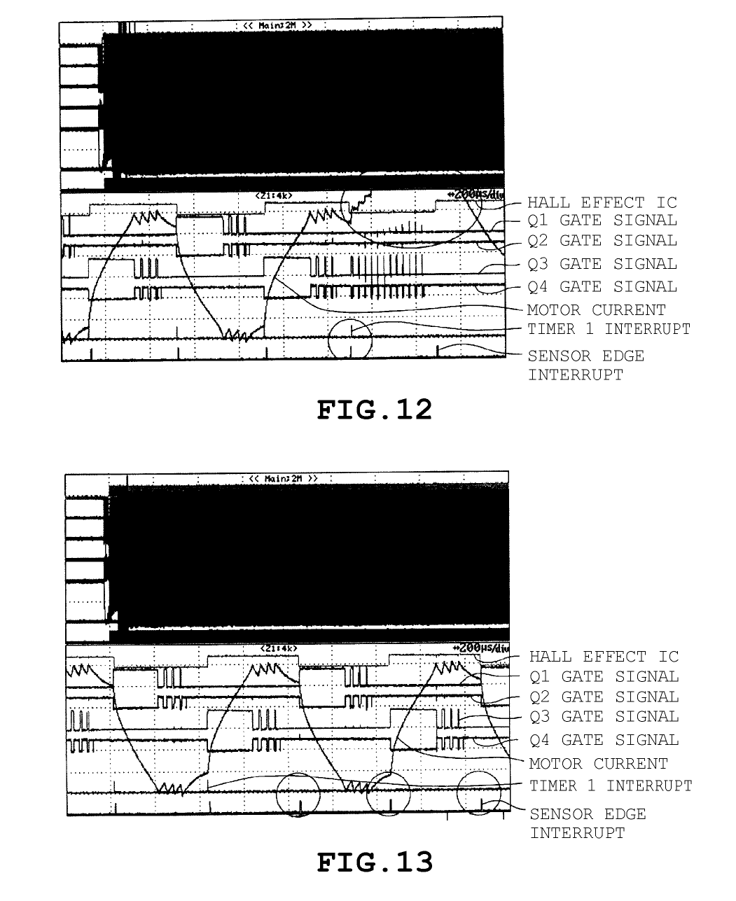

FIG. 12 shows each signal waveform corresponding to the case shown in FIG. 6. In accordance with the occurrence of anomaly, the edge interrupt occurs before the occurrence of a time 1 interrupt. This prevents normal switching of energization direction to the motor 6, and thereby an induced voltage is continuously generated in such a manner as to cause a current to flow in one direction; therefore, a large current flows. FIG. 13 shows each signal waveform corresponding to the case shown in FIG. 10. By performing the timer 1 interrupt processing without generating a timer 1 interrupt in the edge interrupt processing, the energization direction to the motor 6 is normally switched, and therefore a large current does not flow.

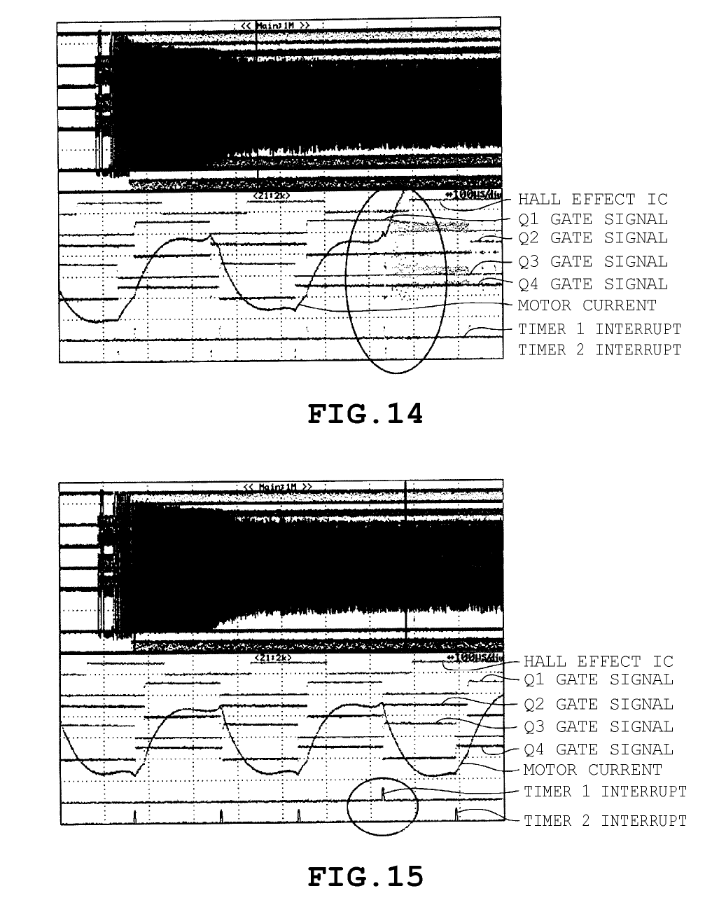

FIG. 14 shows each signal waveform corresponding to the case shown in FIG. 7. In accordance with the occurrence of anomaly, the timer 2 interrupt occurs after the occurrence of the timer 1 interrupt, that is, the order is reversed. This makes a large current flow through the inverter circuit 5. FIG. 15 shows each signal waveform corresponding to the case shown in FIG. 11. By performing the timer 2 interrupt processing without generating a timer 2 interrupt within the timer 1 interrupt processing, the energization direction to the motor 6 is normally switched, and therefore a large current does not flow.

As described above, according to the present invention, the control microcomputer 7 includes the control unit 17 for timer 1 and the control unit 18 for timer 2, activates the timer 1 according to the rotational position of the motor 6, and controls the on-timing of the FET_Q1 and FET_Q3 on the basis of the time counted by the timer 1, and thereby energizes the motor 6. Further, the control microcomputer 7 activates the timer 2 according to the on-timing, controls the off-timing of the FET_Q1 and FET_Q3 on the basis of the time counted by the timer 2, sets the FET_Q2 and FET_Q4 of two opposing arms to be in an on-state to cause a reflux current to flow, and then changes the energization direction to the motor 6. In addition, when the rotational position of the motor 6 is set to a position for activating the timer 1 before the on-timing, turning on of the FET_Q1 and FET_Q3 and activation of the timer 2, which are scheduled to be performed at the on-timing, are carried out.

As a result, even when the subsequent rotational position signal edge occurs before counting of the timer 1 is completed due to an abrupt acceleration of the motor 6 or the like, it is possible to appropriately switch the energization direction to the motor 6 to prevent a large current from flowing in the inverter circuit 5, thereby enabling stable control.

Furthermore, the control microcomputer 7 is configured in such a way as to switch the energization direction to the motor 6 before causing the reflux current to flow in the inverter circuit 5 when the subsequent rotational position signal edge occurs before the timing at which the FET_Q1 and FET_Q3 are turned off. Therefore, when the subsequent rotational position signal edge occurs before counting of the timer 2 is completed as well, it is possible to appropriately switch the energization direction to the motor 6, thereby enabling stable control.

In addition, the current detector 22 is configured in such a way as to detect a current when the off-timing of the FET_Q1 and FET_Q3 is controlled on the basis of time counted by the timer 2, and the control microcomputer 7 is configured in such a way as to switch the energization direction to the motor 6 after causing the current detector 22 to detect a current before causing the reflux current to flow in the inverter circuit 5 when the subsequent rotational position signal edge occurs before the off-timing. As a result, even when the motor 6 abruptly accelerates, current detection can be reliably performed.

### Other Embodiments

A three-phase inverter circuit may be used.

The current detection may be performed only in the timer 2 interrupt processing at the time of anomaly handling.

A switching element is not limited to an MOSFET and may be an IGBT and a bipolar transistor, for example.

While certain embodiments have been described, these embodiments have been presented by way of example only and are not intended to limit the scope of the inventions. Indeed, the novel embodiments described herein may be embodied in a variety of other forms; furthermore, various omissions, substitutions, and changes in the form of the embodiments described herein may be made without departing from the spirit of the inventions. The accompanying claims and their equivalents are intended to cover such forms or modifications as would fall within the scope and spirit of the invention.

1. A motor drive device comprising;
a power conversion circuit that is configured by connecting, in parallel, a plurality of arms respectively including series circuits of respective positive-side and negative-side switching elements, and that drives a motor;
a control circuit generating and outputting an on/off signal to each of the switching elements constituting the power conversion circuit to control the motor; and
a rotational position detector detecting a rotational position of the motor,
wherein the control circuit includes a first timer and a second timer and is configured to:
activate the first timer according to the rotational position, control the on-timing of the positive-side switching elements on the basis of the time counted by the first timer, and thereby energize the motor,
activate the second timer according to the on-timing, control the off-timing of the positive-side switching elements on the basis of the time counted by the second timer, set negative-side switching elements of two opposing arms to be in an on-state to cause a reflux current to flow, and then change an energization direction to the motor, and
when the rotational position is set to a position for activating the first timer before the on-timing, carry out turning on of the positive-side switching elements and activation of the second timer, which are scheduled to be performed at the on-timing.

2. The motor drive device of claim 1, wherein the control circuit is configured to switch the energization direction to the motor before causing the reflux current to flow when the rotational position is set to the position for activating the first timer before the off-timing.

3. The motor drive device of claim 2, comprising a current detector detecting a current flowing in the power conversion circuit,
wherein the current detector is configured to detect the current when the off-timing of the positive-side switching elements is controlled on the basis of time counted by the second timer, and
the control circuit is configured to switch, when the rotational position is set to the position for activating the first timer before the off-timing, the energization direction to the motor after causing the current detector to detect the current, before causing the reflux current to flow.
